(19) United States
(12) Patent Application Publication
(10) Pub. No.: US 2017/0187291 A1
(43) Pub. Date: Jun. 29, 2017

(54) METHOD OF POWERING HIGH FREQUENCY TOOL AND HIGH FREQUENCY POWER PACK THEREFORE

(71) Applicant: SOCIÉTÉ DES ANCIENS ÉTABLISSEMENTS LUCIEN GEISMAR, Neuilly sur Seine (FR)

(72) Inventor: François RENAUD-BYRNE, Mississauga (CA)

(21) Appl. No.: 15/113,774

(22) PCT Filed: Jan. 30, 2015
(86) PCT No.: PCT/EP2015/051999

§ 371 Date: Jul. 22, 2016

Related U.S. Application Data
(60) Provisional application No. 61/933,990, filed on Jan. 31, 2014.

(51) Int. Cl. H02M 3/24; H02M 7/44

(52) U.S. Cl. CPC H02M 3/24; H02M 7/44; E01B 37/00

(57) ABSTRACT

The method of electrically powering a high frequency tool with a battery pack having a DC electrical output can include stepping up the battery pack DC electrical output to a high voltage DC output of above 200V; converting the high voltage DC output to 3 phase alternating current; and powering the high frequency tool using the 3 phase alternating current.

### FIELD

This specification details some embodiments for powering high frequency power tools specifically adapted to the field of railroad construction.

### BACKGROUND

There are many types of power tools and the various types have given strengths and weaknesses which make them better adapted to certain applications. In the field of railroad construction, for instance, transportability is a factor to be considered in the choice of a tool. In this context, not only the tool, but its power source as well, can require a satisfactory degree of transportability. Moreover, many railroad construction tools require high operating speeds.

It was known in the field of railroad construction to power demanding tools using gas or hydraulic power. Although satisfactory to a certain degree, these methods of powering tools had some inconveniences when considering factors such as transportability, operation costs, greenhouse emission production, etc. Accordingly, there remained room for improvement in alleviating at least some of these inconveniences.

### SUMMARY

High frequency (HF) tools are electrically powered tools designed to be powered above the standard mains frequency of 50/60 Hz. Some commonly available HF tools are operated at 300 Hz or 400 Hz for instance, with a three phase electrical current. The high frequency electrical power is particularly useful to drive tools at high speeds (such as grinders for instance). However, the application of former high frequency tool technology to the field railroad construction met many challenges, including the challenge of providing a satisfactorily transportable power pack.

Driving high frequency electrical power with batteries poses a double challenge: firstly, batteries typically provide a Direct Current (DC) voltage rather than an Alternative Current (AC) voltage (let alone high frequency), and secondly because the conversion of DC voltage to tri-phase, high-frequency voltage was known to require a high DC voltage input. Batteries having a suitably high DC voltage are typically very bulky, which would affect the overall transportability of the system.

This application discloses an electrical power pack which can achieve satisfactory transportability while meeting other requirements particular to high frequency tools. This can be achieved by using a low voltage battery having satisfactory transportability, a step-up device to increase the voltage of the battery, and a converter to convert the stepped-up voltage into a 3 phase, high frequency voltage of a satisfactory amplitude for the particular high frequency power tool.

In the context of this application, a high DC voltage can be understood to be a DC voltage of above 200V, preferably above 300V, whereas a low DC voltage is typically below 150V. Low voltage DC batteries can have significantly better transportability than high voltage DC batteries.

In accordance with one aspect, there is provided a method of electrically powering a high frequency tool with a battery pack having a DC electrical output, the method comprising: stepping up the battery pack DC electrical output to a high voltage DC output of above 200V; converting the high voltage DC output to 3 phase alternating current; and powering the high frequency tool using the 3 phase alternating current.

In accordance with another aspect, there is provided a power pack for a high frequency tool, the power pack comprising: a battery having a DC electrical output; a step-up device receiving the electrical output from the battery pack and operable to step up the voltage to a high voltage DC output of at least 200V; and a converter connected to receive the high voltage DC output and operable to convert the high voltage DC output to 3 phase alternating current.

Many further features and combinations thereof concerning the present improvements will appear to those skilled in the art following a reading of the instant disclosure.

### DESCRIPTION OF THE FIGURES

In the figures,

FIG. 1 is a bloc diagram of a power pack for a high frequency tool;

FIG. 2 is a schematic of an example high voltage circuit for the power pack of FIG. 1;

FIG. 3 is a schematic of an example low voltage circuit for the power pack of FIG. 1.

### DETAILED DESCRIPTION

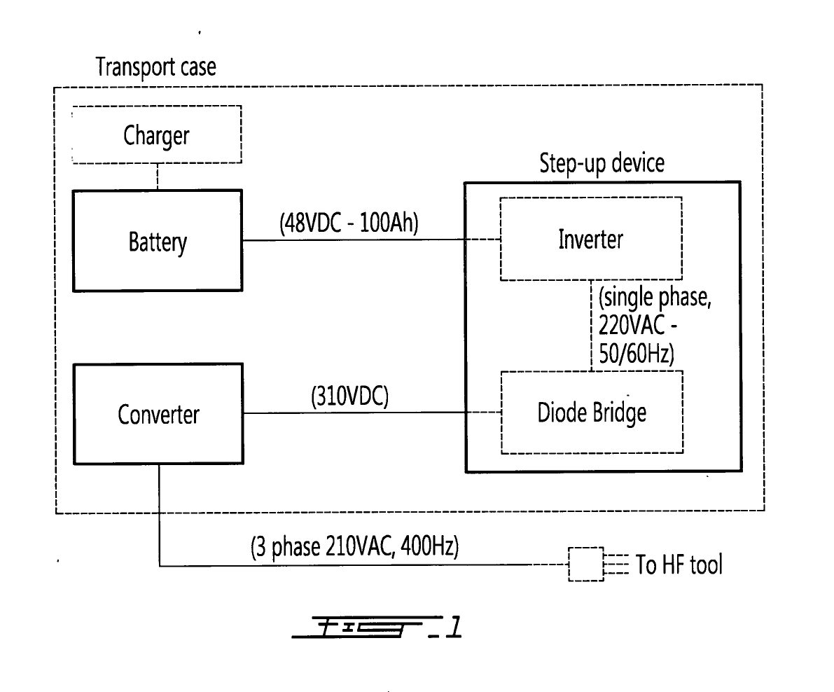

FIG. 1 shows an example of a high frequency power pack for a high frequency power tool. Generally, the electrical power pack includes a battery which provides a low DC voltage electrical output, a step-up device which increases the voltage from the battery output to a higher DC voltage, and a converter which converts the high DC voltage into a high frequency electrical output satisfactory for the high frequency power tool. It will be understood that the battery is selected in order to provide a sufficiently high amount of current to satisfy the demand of the high frequency power tool in addition to electrical losses of the step-up device and/or converter.

In this example, the high frequency power tool requires three phase AC power at 210 VAC, 400 Hz, and the power pack was adapted accordingly. In accordance with specific adaptation to the example three phase, 400 Hz AC power requirement, a 48 VDC battery having a 100 Ah capacity was selected, the step-up device increases the 48 VDC to 310 VDC, and the converter converts the 310 VDC to the three phase 210 VAC, 400 Hz of this embodiment. It will be understood that the exact choice of the electrical/electronic components involved can be adapted to different power requirements in alternate embodiments. For instance, a smaller capacity application can be provided with a battery having a 40 Ah capacity, or even lower.

In this example, the specific step-up device used includes an inverter and a diode bridge in sequence. The inverter converts the 48 VDC into single phase electrical power of 220 VAC, 50/60 Hz, whereas the diode bridge converts the 220 VAC current into 310 VDC.

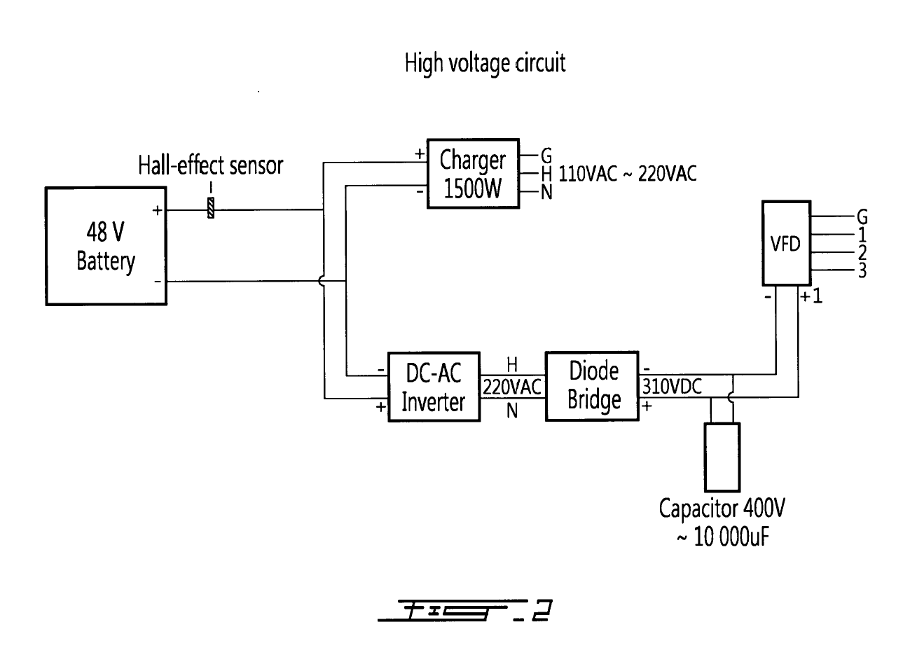

The inverter can be rated 8000 W continuous, 16000 W surge in this embodiment, for instance. To stabilize the output voltage, a capacitor can be used in parallel with the diode bridge. In this specific embodiment, the capacitor is rated for 400V and 10000 uF. A more detailed schematic is provided in FIG. 2. In an alternate embodiment, the step-up device can have a transformer rather than an inverter and diode bridge combination, for instance.

In this specific embodiment, the 310 VDC is converted to meet the high frequency tool requirement using a variable frequency drive (VFD). More specifically, a programmable Yaskawa™ VFD was used in this case. The variable frequency drive parameters were adjusted in order to adapt it for this specific application. More specifically, the parameters were adjusted to provide a constant voltage independently of minor DC voltage fluctuations which may occur at the input depending on the power consumed by the high frequency tool (e.g. between 200 VDC and 330 VDC). Moreover, the parameters were adjusted in order to provide a “torque stall prevention” function by which when the high frequency tool reaches a maximum power output, the operation speed of the tool varies in a manner to be perceptible by the user, who is thus advised of reaching the maximum power output. In this embodiment, the power tool can typically be driven between 200 and 240 VAC.

In this example, the power pack is incorporated in a transport case with an integrated charger, as shown in FIG. 1. The charger can be adapted to charge the battery using a standard 120 or 220 VAC mains, for instance, or using 12 VDC current from a truck alternator, for instance. In the latter configuration, the charger can be used to extend the battery life, for instance. In an alternate embodiment, the battery can be provided separately from the other electronics, e.g. in an independent transport case, in order to allow the battery to be transported separately therefrom.

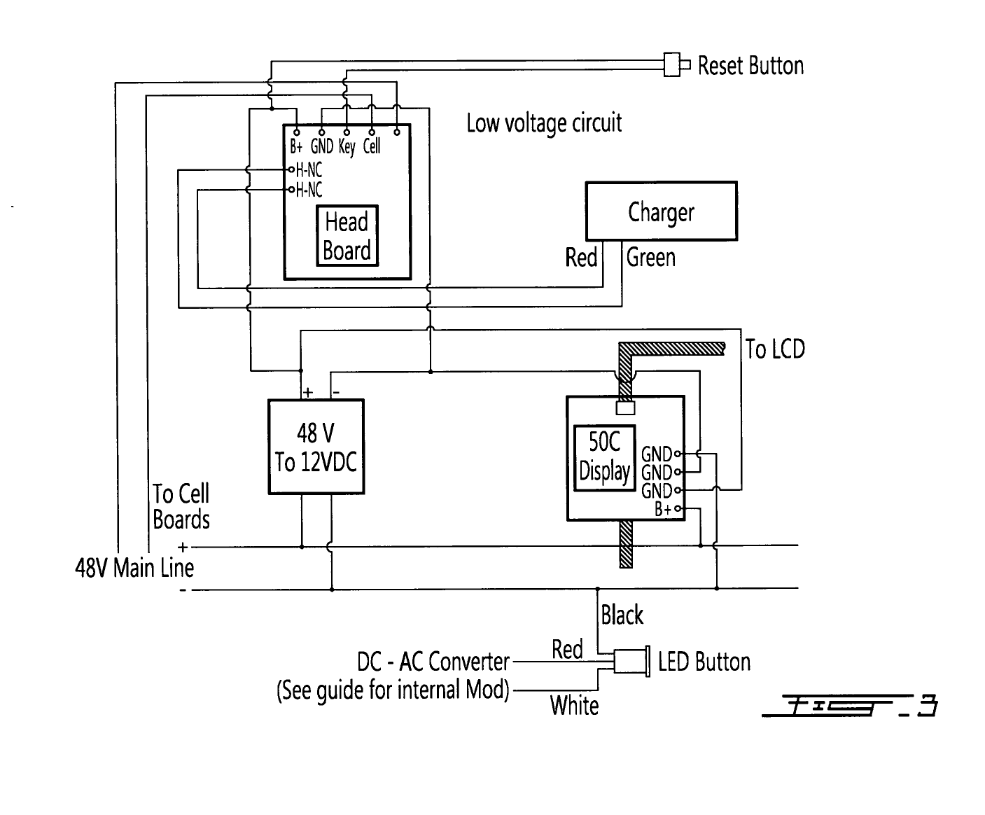

In this example, a low voltage circuit illustrated in FIG. 3 is also used, and was found convenient.

The examples described above and illustrated are intended to be exemplary only. The scope is indicated by the appended claims.

What is claimed is:

1. A method of electrically powering a high frequency tool using a battery pack having a DC electrical output, the method comprising:
stepping up the battery pack DC electrical output to a high voltage DC output of above 200V;
converting the high voltage DC output to 3 phase alternating current; and
powering the high frequency tool using the 3 phase alternating current.

2. The method of claim 1 wherein the stepping up includes converting the battery pack electrical output to single phase alternating current, and converting the single phase alternating current to the high voltage DC output using a diode bridge.

3. The method of claim 2 wherein the stepping up further includes smoothing the high voltage DC output using a parallel capacitance.

4. The method of claim 1 wherein the high voltage DC output is of at least 300 V, and the 3 phase alternating current is of at least 300 Hz.

5. The method of claim 1 further comprising limiting an operating speed of the high frequency tool upon reaching a maximum power output of the high frequency tool.

6. The method of claim 1 wherein the step of converting includes maintaining a constant AC voltage output independently of voltage fluctuations in the high voltage DC output.

7. The method of claim 1 further comprising connecting the high frequency tool to the 3 phase alternating current source.

8. A high frequency power pack for a high frequency tool, the power pack comprising:
a battery having a DC electrical output;
a step-up device receiving the electrical output from the battery pack and operable to step up the voltage to a high voltage DC output of at least 200V; and
a converter connected to receive the high voltage DC output and operable to convert the high voltage DC output to 3 phase alternating current.

9. The power pack of claim 8 further comprising a connector connectable to provide the 3 phase alternating current to the high frequency tool.

10. The power pack of claim 8 wherein the step-up device includes an inverter for converting the battery pack DC electrical output to single phase alternating current, and a diode bridge for converting the single phase alternating current to the high voltage DC output.

11. The power pack of claim 10 wherein the step-up device further includes a capacitor connected in parallel with the diode bridge.

12. The power pack of claim 8 wherein the high voltage DC output is of at least 300 V, and the 3 phase alternating current is of at least 300 Hz.

13. The power pack of claim 8 wherein the battery has a current capacity of at least 10 Ah.

14. The power pack of claim 13 wherein the battery has a current capacity of at least 40 Ah.

15. The power pack of claim 8 wherein the battery is provided in a first module, and the step-up device and the converter are provided in a second module, the first module being selectively connectable to and disconnectable from the second module.
